(19) United States
(12) Patent Application Publication
(10) Pub. No.: US 2026/0235014 A1
(43) Pub. Date: Aug. 13, 2026

(54) VALVES FOR RECIPROCATING DOWNHOLE PUMPS AND RELATED SYSTEMS AND METHODS

(71) Applicant: CHAMPIONX LLC, SUGAR LAND, TX (US)

(72) Inventors: RAMAMURTHY NARASIMHAN, Irving, TX (US); RIPPUDAMAN SINGH, White Settlement, TX (US); ABDUL KADHAR JEELANI C, Virinchipuram (IN); RIYADH SALLOOM, Arlington, TX (US)

(21) Appl. No.: 19/048,259

(22) Filed: Feb. 7, 2025

(51) Int. Cl. E21B 34/08; F16K 15/04

(52) U.S. Cl. CPC E21B 34/08; F16K 15/042; E21B 2200/04

(57) ABSTRACT

A valve may include a valve seat and may include a primary ball sized and positioned to seal against the valve seat when the valve is in a closed state. A valve may additionally include a secondary ball sized and positioned to apply a force against the primary ball to facilitate the sealing of the primary ball against the valve seat when the valve is in the closed state. A valve may include a valve seat that may tilt relative to a longitudinal axis of the valve.

### FIELD OF THE DISCLOSURE

The present disclosure relates valves for use in fluid-handling systems and devices. According to some embodiments, such valves may be implemented downhole linear reciprocating pumps, such as that may be used to pump fluids through an oil well, from a reservoir beneath ground, to a surface location. Specifically, the present disclosure relates to ball-type check valves as used in such pumps or other downhole assemblies.

### BACKGROUND OF THE DISCLOSURE

The exploitation of hydrocarbons contained in the porous space of targeted sub-surface rock formations is often accomplished by means of drilling and completing boreholes, which establish a pathway for the formation fluids to be produced. Well fluids flow through the borehole up to the surface at a rate driven by a pressure differential, which may be connate to the produced rock formation or may be imparted by any form of artificial lift system. Among the multiple artificial-lift methods available in the industry, the utilization of linear-reciprocating pumps, commonly known as sucker-rod pumps, prevails nation and worldwide.

Sucker-rod pumps typically comprise a plunger reciprocating inside a barrel with each of them connected to a one-way check valve thereby forming an internal compression chamber. Sucker-rod pumps operate on the positive-displacement principle; admitting a parcel of fluids from a low-pressure reservoir and into the compression chamber during the first half of the stroke, thereafter, releasing the fluid to the high-pressure outlet during the second half of the stroke. The reciprocating action of the plunger drives the expansion and the contraction of the compression chamber, while the synchronous action of the two check valves controls the admission and the discharge of the fluids. Ball-type one-way check valves comprising a ball and a valve seat disposed inside a cage (or cylindrical casing) are nowadays an industry standard.

In rod lift pumps, traditional standing and traveling valves function effectively in deviated well installations ranging from 2 to 10 degrees. The optimum and swiftest sealing occurs when the ball and valve seat reach a vertical condition. However, as the pump installation angle increases, the sealing efficiency and sealing time will vary depending on the specific operating conditions of each well. In highly deviated conditions, predicting sealing failure becomes more difficult due to changing well conditions and accelerated wear of the valve cage, ball, and valve seat.

Accordingly, it would be desirable to improve the performance of such check valves, especially for non-vertical well installations.

### SUMMARY

In some aspects, the techniques described herein relate to a valve, including: a valve seat; a primary ball sized and positioned to seal against the valve seat when the valve is in a closed state; a secondary ball sized and positioned to apply a force against the primary ball to facilitate the sealing of the primary ball against the valve seat when the valve is in the closed state; and a cage having the primary ball and the secondary ball located therein, the cage configured to contain the primary ball and the secondary ball within the valve and to allow fluid flow through the valve past the primary ball and the secondary ball when the valve is in an open state.

In some aspects, the techniques described herein relate to a valve, wherein a diameter of the secondary ball is smaller than a diameter of the primary ball.

In some aspects, the techniques described herein relate to a valve, wherein the cage includes: a primary ball race having an inner diameter sized to allow the longitudinal movement of the primary ball within the primary ball race; a secondary ball race having an inner diameter smaller than the diameter of the primary ball and larger than the diameter of the secondary ball to allow the longitudinal movement of the secondary ball within the secondary ball race and to prevent the primary ball from entering the secondary ball race; and a tapered transition region between the primary ball race and the secondary ball race.

In some aspects, the techniques described herein relate to a valve, wherein the cage and the secondary ball are sized and configured so that the secondary ball is located in the tapered transition region when the valve is in the closed state.

In some aspects, the techniques described herein relate to a valve, wherein the cage and the secondary ball are sized and configured so that the secondary ball applies a force to the primary ball in a direction that is non-parallel to a longitudinal axis of the valve when the valve is in the closed state.

In some aspects, the techniques described herein relate to a valve, wherein the cage includes: a housing; and an insert positioned within the housing, the insert including a plurality of ribs extending from a base to an apex, the ribs defining a plurality of flow paths therebetween.

In some aspects, the techniques described herein relate to a valve, further including a ball guide positioned proximate the valve seat sized, the ball guide including a tapered opening configured to align the primary ball with the valve seat when the valve is transitioned to a closed state.

In some aspects, the techniques described herein relate to a valve, wherein the valve seat is configured to tilt relative to a longitudinal axis of the valve.

In some aspects, the techniques described herein relate to a valve, wherein the valve seat is positioned in an outer member, the outer member being fixed relative to the cage and the valve seat being rotatable relative to the outer member.

In some aspects, the techniques described herein relate to a valve, further includes a seal between the outer member and the valve seat.

In some aspects, the techniques described herein relate to a valve including a primary ball; a cage having the primary ball located therein, the cage configured to contain the primary ball within the valve and to allow fluid flow through the valve past the primary ball when the valve is in an open state; a valve seat sized and configured to receive the primary ball and provide a seal between the valve seat and the primary ball when the valve is in a closed state, the valve seat configured to tilt relative to a longitudinal axis of the valve.

In some aspects, the techniques described herein relate to a valve, wherein the valve seat is positioned in an outer member, the outer member being fixed relative to the cage and the valve seat being rotatable relative to the outer member.

In some aspects, the techniques described herein relate to a valve, further including a seal between the outer member and the valve seat.

In some aspects, the techniques described herein relate to a valve, wherein an opening of the outer member includes a surface shaped as a portion of a sphere, and an outer surface of the valve seat includes a surface shaped as a portion of a sphere.

In some aspects, the techniques described herein relate to a valve, wherein the outer member includes a slot formed through an end portion and extending in an axial direction to a central portion of the outer member, the slot sized and configured to allow the insertion of the valve seat into or out of the outer member when the valve seat is oriented so that the longitudinal axis of the valve seat is perpendicular to a longitudinal axis of the outer member.

In some aspects, the techniques described herein relate to a valve, further including an obstruction that restricts tilting of the valve seat relative to the outer member to a range less than 90 degrees.

In some aspects, the techniques described herein relate to a method of restricting fluid flow with a valve, the method including: positioning a primary ball against a valve seat; and applying a force to the primary ball in a direction that is non-parallel with a longitudinal axis of the valve with a secondary ball.

In some aspects, the techniques described herein relate to a method, further including tilting the valve seat relative to the longitudinal axis of the valve with the primary ball.

In some aspects, the techniques described herein relate to a method, further including orienting the longitudinal axis of the valve at a non-vertical angle.

In some aspects, the techniques described herein relate to a method, wherein applying a force to the primary ball in a direction that is non-parallel with a longitudinal axis of the valve with a secondary ball further includes applying the force in a direction that is non-vertical.

### BRIEF DESCRIPTION OF THE DRAWINGS

Embodiments of the present disclosure are described herein with reference to the drawings, wherein like parts may be designated by like reference numbers.

FIG. 1 illustrates a sucker-rod pumping system, according to an embodiment of the present disclosure.

FIG. 2 illustrates a cross-sectional view of a sucker-rod pump configuration, according to an embodiment of the present disclosure.

FIG. 3 illustrates a cross-sectional view of a plunger assembly for a sucker-rod pump, such as the sucker-rod pump of FIG. 2, according to an embodiment of the present disclosure.

FIG. 4A illustrates an exploded isometric view of a check valve, according to an embodiment of the present disclosure.

FIG. 4B illustrates an exploded cross-sectional view of the check valve of FIG. 4A.

FIG. 4C illustrates a cross-sectional view of the check valve of FIG. 4A in an assembled configuration and in an open position.

FIG. 4D illustrates a cross-sectional view of the check valve FIG. 4A in an assembled configuration and in a closed position.

FIG. 5A illustrates an angle of the check valve of FIG. 4A relative to a horizontal line.

FIG. 5B illustrates an angle between a line taken from the centers of the balls of the check valve of FIG. 4A relative to a horizontal line.

FIG. 5C illustrates an angle between a tangential line taken at the surface of the secondary ball of the check valve of FIG. 4A where it contacts the insert relative to a horizontal line.

FIG. 6A illustrates a cross-sectional view of a check valve that includes a valve seat assembly having a valve seat configured to tilt relative to a longitudinal axis of the valve, according to an embodiment of the present disclosure.

FIG. 6B illustrates a cross-sectional exploded view of the check valve of FIG. 6A.

FIG. 6C illustrates a cross-sectional view of an outer member and a valve seat of a valve assembly of the check valve of FIG. 6A in an unassembled configuration.

FIG. 6D illustrates a cross-sectional view of the outer member and the valve seat of FIG. 6C in a partially assembled configuration.

FIG. 6E illustrates a cross-sectional view of the outer member and the valve seat of FIG. 6C in a fully assembled configuration.

FIG. 7A illustrates a cross-sectional view of a check valve that includes a valve seat assembly having a valve seat configured to tilt relative to a longitudinal axis of the check valve, utilizing an end plug as an outer member within which the valve seat may tilt, according to an embodiment of the present disclosure.

FIG. 7B illustrates a cross-sectional view of the check valve of FIG. 7A.

FIG. 8 illustrates a cross-sectional view of a barrel assembly for a sucker-rod pump including a dual-ball check valve, according to an embodiment of the present disclosure.

FIG. 9 illustrates a cross-sectional view of a barrel assembly for a sucker-rod pump including a dual-ball check valve and a single-ball check valve, according to an embodiment of the present disclosure.

FIG. 10 illustrates a cross-sectional view of a plunger assembly for a sucker-rod pump including a dual-ball check valve and a single-ball check valve, according to an embodiment of the present disclosure.

FIG. 11 illustrates a cross-sectional view of a plunger assembly for a sucker-rod pump including two dual-ball check valves, according to an embodiment of the present disclosure.

FIG. 12 illustrates a cross-sectional view of a plunger assembly for a sucker-rod pump including an open-cage dual-ball check valve, according to an embodiment of the present disclosure.

### DETAILED DESCRIPTION

The present disclosure relates, in some embodiments, to check valves, for example, as used in downhole reciprocating sucker-rod pumping systems that produce oil from oil wells. It should be appreciated, however, that the scope of the claims issuing from this specification shall determine the disclosure as hereinafter claimed, and that this statement of certain embodiments should not be used to narrow the disclosure. Further, in additional embodiments, the valves herein may be implemented in other devices or assemblies (e.g., plunger lift systems, jet lift systems, artificial lift systems controlling one-way fluid flow, etc.).

As used herein, the term “substantially” or “about” in reference to a given parameter means and includes to a degree that one skilled in the art would understand that the given parameter, property, or condition is met with a small degree of variance, such as within acceptable manufacturing tolerances. For example, a parameter that is substantially met may be at least 90% met, at least 95% met, at least 99% met, or even 100% met.

As used herein, the term “fluid” may mean and include fluids of any type and composition. Fluids may take a liquid form, a gaseous form, or combinations thereof, and, in some instances, may include some solid material. In some embodiments, fluids may convert between a liquid form and a gaseous form during a cooling or heating process as described herein. In some embodiments, the term fluid includes gases, liquids, and/or pumpable mixtures of liquids and solids.

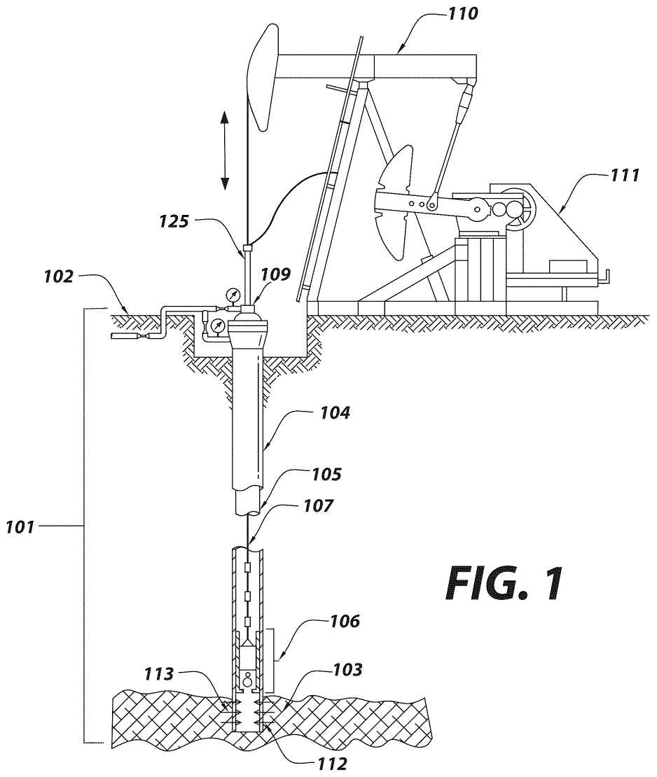

FIG. 1 illustrates a sucker-rod pumping system for a producing oil well 101 according to an embodiment of the present disclosure. The well 101 has a borehole that extends from the surface 102 and into the earth, past an oil-bearing formation 103. A string of tubing known as casing 104 may run through the borehole 101 and it may be cemented in place to seal the well from the surroundings. The casing 104 may include perforations 112 at the targeted formation 103 to provide a path for the formation fluids 113 to flow into the well. A string of tubing 105 may extend inside of the casing 104 from the formation 103 to the surface 102.

A subsurface sucker-rod pump 106 may be located inside or below the tubing 105 at or near the targeted formation 103. A string of sucker rods 107 may extend from the sucker-rod pump 106 up inside of the tubing 105 to a polished rod 125, which may rest on the carrier bar of a beam pumping unit 110. A stuffing box 109 located on the surface 102 may provide a dynamic seal against the polished rod 125, containing the well pressure and preventing the spillage of formation fluids 113 at the surface 102. The beam pumping unit 110 may be caused to reciprocate up and down with to a prime mover 111, such as an electric motor or a gasoline, gas, or diesel engine, and the reciprocation action may be transferred to the downhole pump 106 through the sucker-rod string 107.

The sucker-rod pump 106 may exert mechanical work on the well fluids, providing the pressure head necessary for the formation fluids 113 to reach the surface 102. The formation fluids 113 may circulate through the sucker-rod pump 106 in packets, with formation fluids 113 typically admitted to the pump 106 during the upstroke and ejected during the downstroke.

Sucker-rod pumps 106 can be installed in almost any section of the well 101, although they are typically landed close to the casing perforations 112. Pumps installed in a straight vertical section of the well may outperform pumps installed in inclined, curved, or horizontal sections. Sucker-rod pumps 106 typically admit fluids from the bottom end (down well) and discharge the fluids from the top end of the pump. Since sucker-rod pumps 106 may be placed in non-vertical sections of the well, “TOP” and “BOTTOM” labels may become unclear, hence, in the present disclosure “TOP” refers to the uppermost point or the point closest to the surface 102 along path of the well (e.g., uphole). Similarly, “BOTTOM” refers to the lowermost point or the point farthest from the surface 102 along the path of the well e.g., downhole).

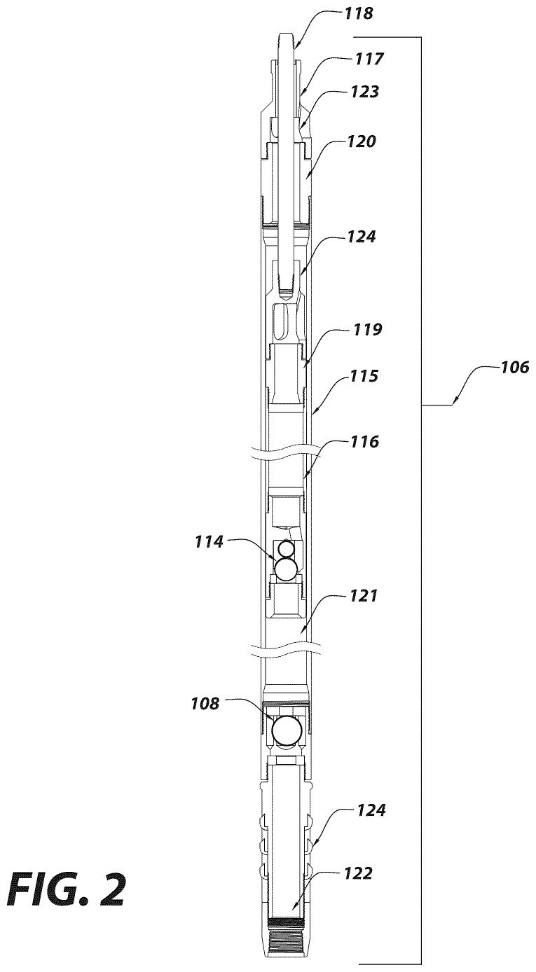

FIG. 2 illustrates a cross-sectional view of the sucker-rod pump 106 of the sucker-rod pumping system of FIG. 1, according to an embodiment of the present disclosure. The sucker-rod pump 106 may include a barrel 115, a plunger 116, a valve rod 118, and two or more check valves 108, 114. Components typically connect to another component by means of matching internal and external threads, or in some instances, bushings, couplings, or connecters 119, 120 interface between the non-matching threaded connections on two given components. Components such as valve rod guides 117 may fulfill a non-primary function for extending the life or improving the performance of the sucker-rod pump 106.

The sucker-rod pump 106 may operate similarly to a linear reciprocating piston pump. The plunger 116 may have a polished outside diameter (OD) that reciprocates within the barrel 115 having a polished inside diameter (ID). A tight clearance between the two polished surfaces may create a dynamic fluid seal. The barrel 115 may be affixed to the tubing 105 by a hold-down assembly 124, while the plunger 116 may be connected to the valve rod 118, which in turn may connect to the sucker-rod string 107. The barrel 115 and the plunger 116 may each be connected to a respective check valve 108, 114. The check valve 108 connected to the barrel 115 may be referred to as the “standing-valve,” and the check valve 114 connected to the plunger 116 may be referred to as the “travelling valve.”

An alternate pump configuration may use a plunger 116 fixed to the tubing 105 by means of a hold-down assembly 124, and a reciprocating barrel 115 connected to the sucker-rod string 107, in which case the “travelling” and “standing” designations will be inverted. In either case, at least two valves may be utilized in a sucker-rod pump assembly.

One or more of the check valves 108, 114 may be a ball-type check valve according to an embodiment of the present disclosure as described in more detail below.

A compression chamber 121 may be formed inside the barrel 115 in the volume enclosed between the check valves 108, 114. The volume of the compression chamber may expand during the upstroke and shrink during the downstroke movements of the plunger 116. The pumping cycle may begin with the plunger 116 at the bottom dead center of the stroke and moving upwards. During the upstroke movement, formation fluids 113 may enter the pump 106 from the bottom inlet 122, flowing through the opened standing valve 108 and into the compression chamber 121. Meanwhile, the travelling valve 114 may remain closed due to the hydrostatic fluid column located above the travelling valve 114. Formation fluids 113 may be driven into the compression chamber 121 by a transient drop in the pressure caused by the expanding volume of the chamber during the upstroke. Upon reaching the top dead center, the standing valve 108 may close as the expansion of the compression chamber 121 ceases, and the plunger 116 begins to move downward transferring the hydrostatic load from the travelling valve 114 to the standing-valve 108, and forcing the standing-valve 108 to close and compressing the formation fluid 113 trapped in the chamber 121. At some point during the downstroke, the pressure inside the compression chamber 121 and the pressure on top of the travelling-valve 114 may equalize, which may force the travelling valve 114 to open and the fluid in the shrinking compression chamber 121 to flow out of it. The next pumping cycle may begin when the plunger 116 reaches the bottom dead center again.

The check valves 108, 114 may be actuated by pressure differentials in the fluid exceeding the cracking pressure of the respective valve. In an ideal scenario, the travelling valve 114 and the standing valve 108 would operate synchronously, with one valve opening while the other one closes, ensuring that at no point in time there will be direct fluid communication between the high-pressure outlet 123 and the low-pressure inlet 122 of the pump 106. Similarly, it would be ideal if at no point in time both valves are simultaneously in the closed position. In actual operation, however, the valves may not react instantaneously to a given pressure differential and multiple factors may delay their opening or closing, among many others factors; the ball weight, the fluid drag, the orientation of the pump, the compressibility of the fluids, the flowrate, the presence of solids in the fluid, and the deterioration of the ball and valve seat seals may be the most impactful. Any delay in the actuation of the valves 108, 114 may reduce the volumetric efficiency of the pump 106.

All the components of the pump 106 that are in contact with moving fluids offer some sort of restriction to the flow causing a non-reversible pressure-drop. Even though the pump design can be optimized to reduce the impact of frictional pressure-losses in the performance of the system, pressure-losses are inherent to the flow of fluids and they cannot be eliminated altogether. The performance of the pump is especially sensitive to frictional pressure losses in the low-pressure region of the pump 106; which encompasses all the components between the intake and the compression chamber 121. In the low-pressure region of the pump 106 the fluids may reach the lowest pressure point in the system, which may cause volatiles compounds in the well fluids to flash out forming or expanding the gaseous phase, filling the compression chamber 121 and preventing the desirable entry of incompressible liquids. A compression chamber 121 filled with compressible fluids translates into lower production rates, which is costly and therefore undesirable from an operational standpoint. Nonetheless sucker-rod pumps 106 are designed to pump incompressible liquids, they can handle a certain amount of compressible fluids including volatile compounds and even a free-gas phase, that is, subject to a lower volumetric efficiency and potentially a shorter run life.

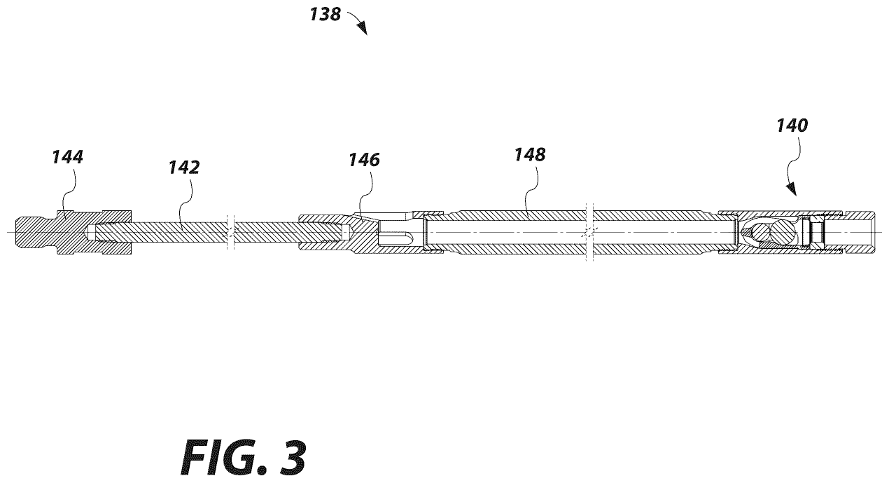

FIG. 3 illustrates a partial cross-sectional view of a plunger assembly 138 for a sucker-rod pump, such as the sucker-rod pump 106 shown in FIG. 2, according to an embodiment of the present disclosure. The plunger assembly 138 may include a valve rod 142, a valve rod bushing 144, a plunger coupler 146, a plunger 148, and the valve 140. The valve rod bushing 144 may be configured to couple the valve rod 142 to the beam pumping unit 110 (see FIG. 1) to facilitate the upward and downward movement of the plunger assembly 138 within the barrel 115. Likewise, the plunger coupler 146 may be configured to couple the valve rod 142 to the plunger 148.

The plunger 148 may include a fluid passage therein for transporting formation fluids 113 up the well to the surface 102 and the plunger coupler 146 may include fluid openings allowing the formation fluids 113 to flow out of the plunger 148. The check valve 140 may inhibit fluid from flowing out of the plunger 148 as the plunger assembly 138 is lifted up the well 101 by the beam pumping unit 110.

In some cases, a well may be non-vertical (as used herein, the term “non-vertical” means oriented at an angle non-parallel to a primary gravitational field (e.g., non-parallel to Earth's gravitational field, and/or out of plumb)) and oriented at a substantial deviation angle and/or may be at or near a horizontal orientation. In such cases, valves according to embodiments of the present disclosure may provide improved performance, such as improved sealing when the valve is in a closed state. For example, valves according to embodiments of the present disclosure may be utilized in wells with lift pumps oriented at a deviation angle from vertical ranging from about 2 degrees to about 80 degrees.

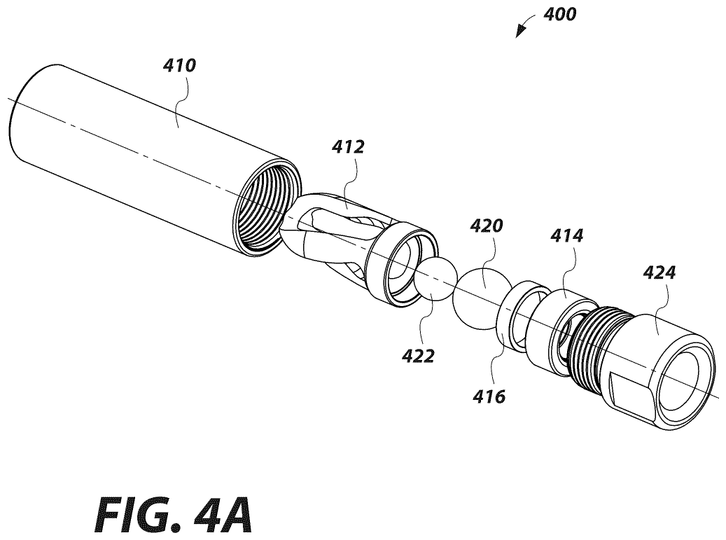

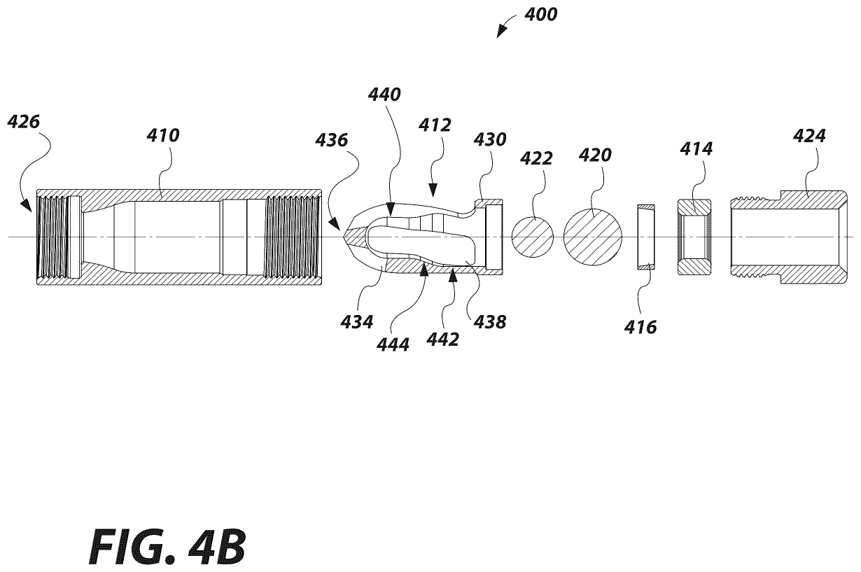

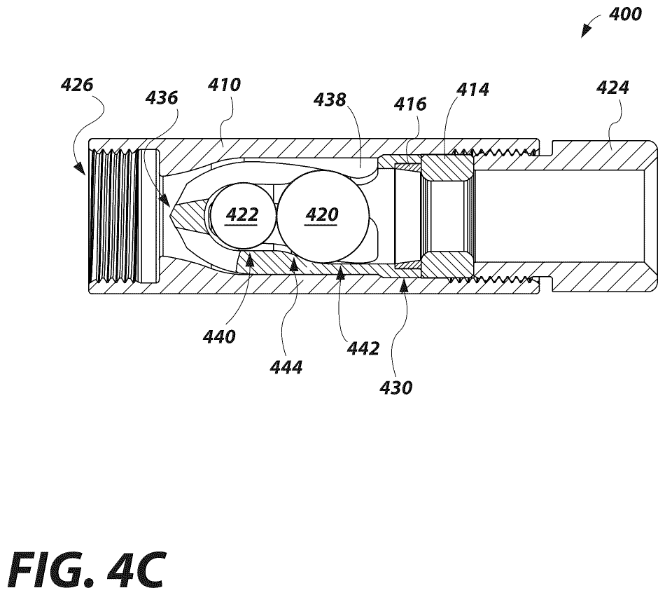

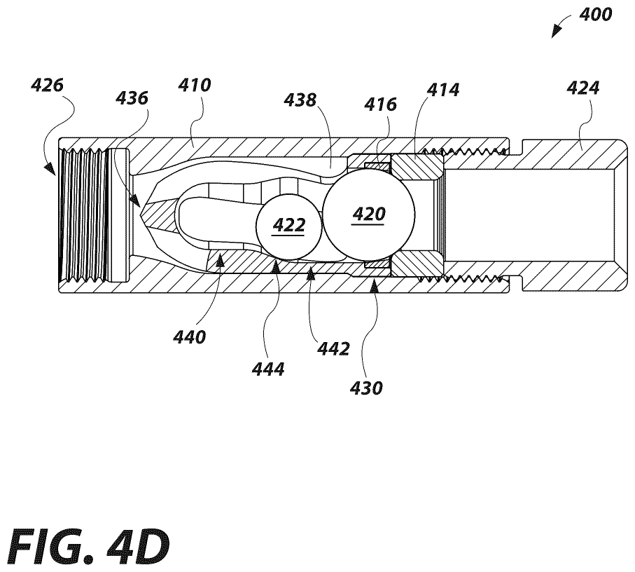

FIG. 4A illustrates an exploded isometric view of a check valve 400, such as may be utilized for the check valve 108, 114, 140 of FIGS. 2 and 3, according to an embodiment of the present disclosure. The check valve 400 may include a valve housing 410, an insert 412, a valve seat 414, a ball guide 416, a primary ball 420, a secondary ball 422, and an end plug 424.

FIG. 4B illustrates an exploded cross-sectional view of the check valve 400 of FIG. 4A.

FIG. 4C illustrates a cross-sectional view of the check valve 400 of FIG. 4A in an assembled configuration and in an open position, with the primary ball 420 spaced apart from the valve seat 414.

FIG. 4D illustrates a cross-sectional view of the check valve 400 of FIG. 4A in an assembled configuration and in a closed position, with the primary ball 420 resting against a lapped sealing surface of the valve seat 414.

The check valve 400 allows fluids to flow only in one pre-specified direction (e.g., from bottom to top) while offering a high resistance to the flow in the opposite direction. Accordingly, when sufficient fluid pressure is applied to the primary ball 420 through the valve seat 414 the primary ball 420 may lift away from the valve seat 414 and the primary ball 420 and the secondary ball 422 may lift to the fully open position shown in FIG. 4C and allow fluid to flow upwards through the check valve 400. When the fluid pressure below the primary ball 420 is reduced, the primary ball 420 may move due to gravity and hydraulic forces to become seated on the valve seat 414 and the secondary ball 422 may apply force to the primary ball 420 to improve the sealing performance of the check valve 400 (e.g., by the secondary ball 422 assisting in aligning the primary ball 420 with the centerline of seat to assist in proper seating). The check valve 400 may then be positioned in the fully closed position as shown in FIG. 4D and fluid flow may be inhibited through the check valve 400. The open position of the check valve 400, enables a fluid connection between the top and the bottom ends of the check valve 400, allowing for upward-moving well fluids to flow around the balls 420, 422, through the insert 412, and out of the top of the check valve 400. The closed position of the check valve 400 provides a seal between the primary ball 420 and the valve seat 414 inhibiting well fluids from flowing downward through the check valve 400.

In some embodiments, the ball guide 416 is positioned proximate the valve seat 414 and may comprise a tapered opening configured to align the primary ball 420 with the valve seat 414 when the valve 400 is transitioned to the closed state. In some embodiments, the ball guide 416 may also provide a secondary sealing surface (e.g., in addition to the valve seat 414).

As shown in FIGS. 4A-4D, the valve housing 410 may be sized to receive the insert 412, the primary and secondary balls 420, 422, the ball guide 416, and the valve seat 414 therein and may include an upper threaded end 426 configured to connect to an uphole component and may include a lower threaded end configured to connect to a downhole component.

The valve housing 410 may have a generally cylindrical shape with an outer diameter (OD) that may range from about 1 inch to about 6 inches, or even greater. The OD of the valve housing 410 may be determined by the size of the pump, with pumps sizes generally following guidelines provided by the American Petroleum Institute. Including both API or non-API configurations, common pump sizes in inches are as follow; about 1 inch, about 1 1/16 inches, about 1¼ inches, about 1½ inches, about 1¾ inches, about 1 25/32 inches, about 2 inches, about 2¼ inches, about 2½ inches, about 2¾ inches, about 3¼ inches, about 3½ inches, about 3¾ inches, about 4¾ inches, about 5¾ inches, and about 6 inches, where about includes plus or minus ⅛ inches. In some embodiments, valve housing 410 may have an outside diameter of about 1 inches, or about 1 1/16 inches, about 1¼ inches, about 1½ inches, about 1¾ inches, about 1 25/32 inches, about 2 inches, about 2¼ inches, about 2½ inches, about 2¾ inches, about 3¼ inches, about 3½ inches, about 3¾ inches, about 4¾ inches, about 5¾ inches, and about 6 inches, where about includes plus or minus ⅛ inches.

The check valve 400 may connect to other components such as by external and/or internal threads, such as the upper threaded end 426 of the valve housing 410. The check valve 400 may be installed on mating components by applying torque to the threaded connections 426, which creates a compressive force on the sealing surfaces providing a fluid seal that is substantial for the intended downhole application. The torque is may be applied or counteracted on the check valve 400 by means of a friction wrench sized for the specific OD of the valve housing 410. Additionally, in some embodiments, the check valve 400 may incorporate a pair of parallel flat surfaces located equidistant to the cylindrical casing axis on diametrically opposed planes or “flats,” to allow for standard flat-wrenches to be using for installing or removing the check valve 400 from the mating components.

The valve housing 410 can be manufactured in different materials, including but not limited to; low alloy steels such as AISI 8620/8630, free machining brass such as CDA 360, austenitic stainless steels such as AISI 303, 304, or 316, duplex stainless steels such as 2205, 2304, 2207, 2507, LDX 2101, and/or nickel alloys such as Monel or Inconel. The corrosion and abrasion properties of the base material in the valve housing 410 may be improved by means of the application of thin-layer coatings or surface treatments, internally and/or externally. Such processes may include electroplating, electroless plating, chemical and physical vapor deposition, plasma coatings, spray-metal coatings, solid-state diffusion treatments, surface heat-treat processes, among others.

The insert 412, which may be referred to, alone or in combination with the valve housing 410, as a “cage,” may comprise a base 430 and a plurality of ribs 434 extending from the base 430 to an apex 436. The plurality of ribs 434 may define a plurality of openings 438 therebetween to allow the passage of fluid around the primary ball 420 and the secondary ball 422 and through the valve 400 to the plunger 148. There may be an equal number of ribs 434 and plurality of openings 438, and both may be symmetrically arranged around the longitudinal axis of the valve housing 410. In some embodiments, the insert 412 may comprise different materials, including but not limited to cobalt-based alloys, chrome-based alloys, nickel-based alloys, low alloy steels, brass alloys, stainless steel alloys, and/or duplex stainless steels. Additionally, the insert 412 may comprise different surface lining processes such as TIG welding and MIG welding, but also electroplating, electroless plating, CVD, PVD, electroforming, in-situ casting, 3D printing, laser-surface hardening, among others. In some embodiments, the insert 412 may be made of a cobalt alloy and surfaces of the insert 412, such as interior surfaces, may be lined with a wear resistant material.

In some embodiments, the plurality of ribs 434 may extend toward the apex 436 along a twisted path, such as a helical path and/or a spiral path. Accordingly, both the plurality of ribs 434 and the plurality of openings 438 may exhibit a twisted, helical, and/or spiral shape, which may impart a swirling effect to fluids passing through the plurality of openings 438 and create a fluid vortex.

The plurality of ribs 434 may additionally define various regions within the insert 412. The plurality of ribs 434 may define a primary ball race 440 having an inner diameter sized to allow the longitudinal movement of the primary ball 420 within the primary ball race 440. The plurality of ribs 434 may additionally define a secondary ball race 442 having an inner diameter smaller than the diameter of the primary ball 420 and larger than the diameter of the secondary ball 422 to allow the longitudinal movement of the secondary ball 422 within the secondary ball race 442 (e.g., and beyond to the primary ball race 440) and to prevent the primary ball 420 from entering the secondary ball race 442. Furthermore, the plurality of ribs 434 may define a tapered transition region 444 between the primary ball race 440 and the secondary ball race 442. A portion of an outer surface of the plurality of ribs 434 may be sized to substantially match an inner diameter of the valve housing 410 and may provide a press-fit between the valve housing 410 and the insert 412.

In some embodiments, centerlines of the primary ball race 440 and the secondary ball race 442 may be substantially aligned (e.g., coextensive) or may be offset (e.g., parallel to each other or transverse to each other).

In some embodiments, the primary ball race 440 may be sized and configured to allow the primary ball 420 to travel longitudinally within the primary ball race 440 a distance between about 0.5 times the diameter of the primary ball 420 and about 1.5 times the diameter of the primary ball 420. Likewise, in some embodiments, the secondary ball race 442 may be sized and configured to allow the secondary ball 422 to travel longitudinally within the secondary ball race 442 a distance between about 0.5 times the diameter of the secondary ball 422 and about 1.5 times the diameter of the secondary ball 422.

In some embodiments, the travel length of the primary ball 420 may be substantially the same as the secondary ball 422.

The diameter of the primary ball race 440 may be defined as the diameter of the primary ball 420 plus a clearance. Likewise, the diameter of the secondary ball race 442 may be defined as the diameter of the secondary ball 422 plus a clearance. The clearance may range from about 1/32 inches to ⅛ inches, not excluding clearances of less than about 1/32 inches or more than about 1/16 inches. In some embodiments, a clearance may be about ½ inches, about ⅛ inches, or about 1/16 inches, or about 1/32 inches, where about includes plus or minus 1/64 inches. The clearance may impact the ability of the check valve 400 to operate in the presence of solids, for example, a larger clearance, such as about 1/16 inches to about 5/32 inches, may be used when pumping solid-laden fluids to reduce the probability of a ball 420, 422 becoming stuck due to the buildup of material between the ball 420, 422 and the ball race 440, 442. Relatively large clearances may be chosen when pumping viscous fluids to reduce the drag on the balls 420, 422 while falling, thereby increasing the free-fall velocity and thereby shortening the closing time of the check valve 400.

The valve seat 414 may be lapped to receive a specific primary ball 420 size, creating a fluid seal when the two come in contact. The primary ball 420 may be spherical and symmetric around its center, providing an “infinite seal,” given that a fluid seal can be accomplished regardless of the primary ball 420 orientation with respect to the valve seat 414. The primary ball 420 and the valve seat 414 may operate as a pair, with limited interchangeability of the valve seat 414 and/or the primary ball 420 size. For example, a given valve seat 414 may be lapped to receive a single size of primary ball 420.

The diameter of the primary ball 420 may range from 0.500 inches to 3.500 inches, or larger, with some sizes specified by industry standards such as those provided by API. Including API and non-API sizes, the primary ball 420 may include a diameter ranging from about 0.500 inches to about 3.500 inches. For example, the primary ball 420 may have the following diameters: about 0.500 inches, about 0.625 inches, about 0.688 inches, about 0.750 inches, about 0.875 inches, about 1.000 inches, about 1.125 inches, about 1.250 inches, about 1.375 inches, about 1.500 inches, about 1.688 inches, about 1.750 inches, about 1.875 inches, about 2.000 inches, about 2.125 inches, about 2.250 inches, about 2.375 inches, about 2.500 inches, about 2.750 inches, about 2.875 inches, about 3.00 inches, about 3.125 inches, about 3.250 inches, about 3.375 inches, and about 3.500 inches, where about includes plus or minus 0.063 inches.

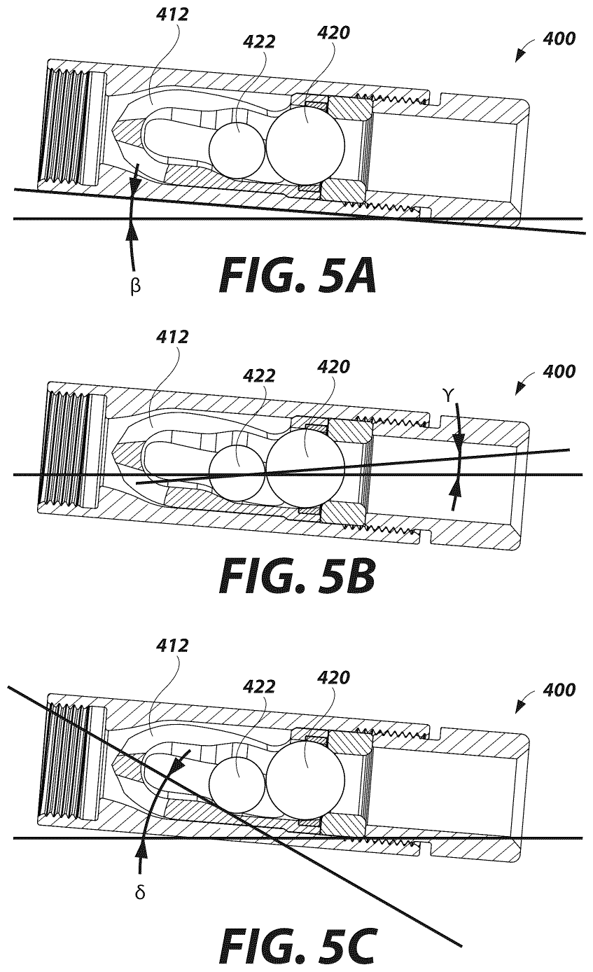

The primary ball 420 size and mass may be selected based on what works well in each region, and the secondary ball 422 may be selected based on a size and mass calculated to provide a wedge to the primary ball 420 to ensure adequate efficiency for opening and closing. The ratio of the mass of the primary ball 420 to the mass of the secondary ball 422 may be determined utilizing equation 1 below, which utilizes geometries measured when the balls 420, 422 are located in the closed position within the valve 400, as shown in FIG. 4D and FIGS. 5A-5C.

$$\frac{M}{m} = \frac{Cos ( Υ ) ( Sin ( β ) Cos ( δ ) + Cos ( β ) Sin ( δ ) )}{( 1 - Sin ( β ) ) ( Cos ( Υ ) Cos ( δ ) - Sin ( Υ ) Sin ( δ ) )} \qquad ( equation 1 )$$

Wherein, M is the mass of the primary ball 420, m is the mass of the secondary ball 422, β is the angle of the check valve 400 relative to a horizontal line (see FIG. 5A), Υ is the angle between a line taken from the centers of the balls 420, 422 and a horizontal line (see FIG. 5B), and 8 is the angle between a horizontal line and a tangential line taken at the surface of the secondary ball 422 where it contacts the insert 412 (see FIG. 5C where the secondary ball 422 contacts the insert 412 at the tapered transition region 444 or beyond in the primary ball race 440).

Accordingly, the geometries of the primary ball 420, the secondary ball 422, and the insert 412, along with the orientation of the check valve 400 relative to horizontal and the masses of the balls 420, 422 may interact to affect the function of the check valve 400 and the direction and magnitude of the force applied to the primary ball 420 by the secondary ball 422. The orientation of the check valve (e.g., β) and the size and mass (e.g., M) of the primary ball 420 may be determined by the properties of a specific well, including the deviation angle of the well and the properties of the formation fluids. In view of this, the mass (e.g., m) and size of the ball may be selected to achieve a desired force to be applied to the primary ball 420 during operation of the check valve 400. Additionally, the geometry of the insert 412, such as the shape of the tapered transition region 444 between the primary ball race 440 and the secondary ball race 442, may be selected to alter the contact angle (e.g., δ) between the insert 412 and the secondary ball 422.

For a given primary ball 420 size and check valve 400 orientation, a secondary ball 422 may be selected with a size that will be sufficiently smaller than the primary ball 420 to provide a contact location that is on a lower portion of the primary ball 420. The contact location between the primary ball 420 and the secondary ball 422 may facilitate the direction that the force is applied to the primary ball 420 from the secondary ball 422. Additionally, the geometry of the tapered transition region 444 of the insert 412 and the mass of the secondary ball 422 may contribute to the magnitude of the force applied to the primary ball 420 from the secondary ball 422. Due to the position of the smaller secondary ball 422 relative to the relatively larger primary ball 420, the force applied to the primary ball 420 by the secondary ball 422 may have a component that is in an upward direction, which may balance the downward force applied to the primary ball 420 by gravity, such that the force applied to the valve seat 414 by the primary ball 420 may be more central and balanced over the valve seat 414. The remaining component of the force applied to the primary ball 420 by the secondary ball 422 may be substantially in an axial direction relative to the valve seat 414, which may create a greater sealing force between the primary ball 420 and the valve seat 414.

The primary ball 420 and the valve seat 414 may be made of similar materials, and the valve seat may be slightly harder than the primary ball 420. Materials that may be used for the balls 420, 422 and the valve seat 414 are cobalt alloys, martensitic stainless steels, and ceramics such as tungsten or chromium carbide. The balls 420, 422 and the valve seats 414 made of different materials can be used together, for example, a tungsten carbide valve seat 414 may be used together with a matching size chromium carbide primary ball 420. Different materials have different densities resulting in lighter or heavier balls 420, 422; lighter balls offering a lower cracking pressure than heavier balls and therefore may be chosen for applications with low intake pressures. On the other hand, heavier balls 420, 422 may be used for applications with highly viscous fluids, as they may be able to close faster.

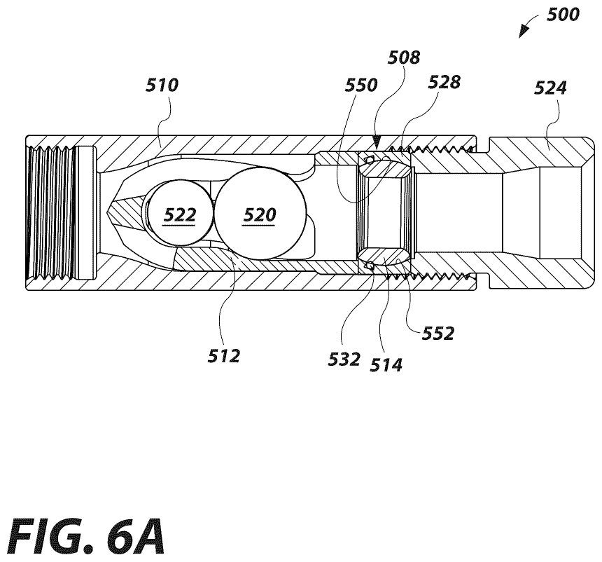

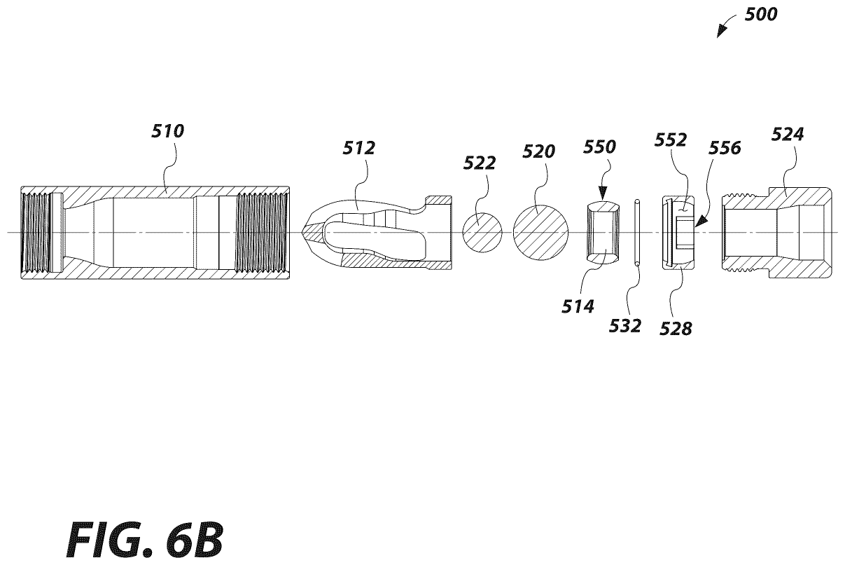

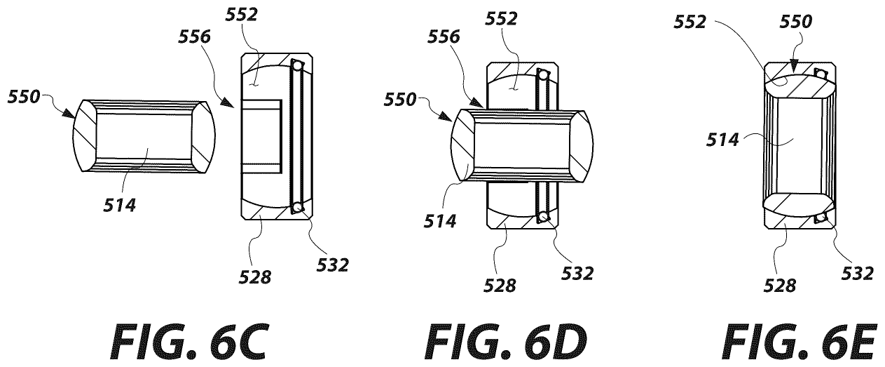

FIG. 6A illustrates a cross-sectional view of a check valve 500 that includes a valve seat assembly 508 having a valve seat 514 configured to tilt relative to a longitudinal axis of the valve 500 according to an embodiment of the present disclosure. In some embodiments, the valve seat 514 may tilt (e.g., rotate) relative to a centerline of the check valve 500 and/or relative to other components of the check valve 500.

The check valve 500 may have similarities to the check valve 400 described with reference to FIGS. 4A-4D. The check valve 500 may have a valve housing 510 that may be substantially the same as the valve housing 410, an insert 512, which may be referred to, alone or in combination with the valve housing 510, as a “cage,” that may be substantially the same as the insert 412, a primary ball 520 that may be substantially the same as the primary ball 420, and a secondary ball 522 that may be substantially the same as the secondary ball 422. Due to the check valve 500 including a valve seat 514 that may tilt, unlike the valve seat 414 of the check valve 400, which may be a single, stationary component, the check valve 500 may operate in a non-vertical orientation without the secondary ball 522 in some embodiments, thus the inclusion of the secondary ball 522 is optional. The valve seat assembly 508 may be held in place by an end plug 524 attached to the valve housing 510 via a threaded connection. In some embodiments, the valve seat 514 and/or the outer member 528 of the valve seat assembly 508 may be made of one or more of silicon nitride, stainless steel, DUMORE® alloy, titanium carbide, tungsten carbide, nickel carbide, or various ceramics-based materials.

FIG. 6B illustrates a cross-sectional exploded view of the check valve 500. As shown, the valve seat assembly 508 may comprise multiple components including the valve seat 514, an outer member 528, and a seal 532 (e.g., an O-ring). Referring again to FIG. 6A, the valve seat 514 may be positioned within the outer member 528 and the outer member 528 may be fixed relative to the insert 512 and the valve housing 510 via the end plug 524. An outer surface 550 of the valve seat 514 may be shaped as a portion of a sphere, and a mating inner surface 552 of the outer member 528 may also be shaped as a portion of a sphere, like a ball and socket joint. Accordingly, the valve seat 514 may be rotatable relative to the outer member 528 in every direction and may tilt about a central longitudinal axis. The seal 532 may be positioned within a channel formed in the mating inner surface 552 of the outer member 528 and may inhibit the passage of fluid between the valve seat 514 and the outer member 528. When the valve seat assembly 508 and the end plug 524 are installed in the valve housing 510, the end plug 524 may be positioned to allow a limited amount of tilting rotation of the valve seat 514 within the outer member 528, but may provide an obstruction that restricts tilting of the valve seat 514 relative to the outer member 528. For example, the end plug 524 may be positioned to restrict tilting rotation of the valve seat 514 within the outer member 528 to a range less than about 90 degrees, to a range less than about 45 degrees, to a range less than about 30 degrees, to a range less than about 20 degrees, to a range less than about 10 degrees, and/or to a range less than about 5 degrees.

In some embodiments, the valve seat 514 may tilt (e.g., rotate) relative to a centerline of the check valve 500, tilt about a radial axis of the valve seat 514, and/or tilt relative to other components of the check valve 500 (e.g., the valve housing 510, the insert 512, the outer member 528, combination thereof).

FIG. 6C-6E illustrates a cross-sectional view of the outer member 528 and valve seat 514 of the valve assembly 508 of FIG. 6B, from an unassembled configuration in FIG. 6C, a partially assembled configuration in FIG. 6D, and a fully assembled configuration in FIG. 6E. The outer member 528 may include a slot 556 formed through an end portion and extending in an axial direction to a central portion of the outer member 528, the slot 556 sized and configured to allow the insertion of the valve seat 514 into or out of the outer member 528 when the valve seat 514 is oriented so that the longitudinal axis of the valve seat 514 is perpendicular to a longitudinal axis of the outer member 528.

FIG. 6D shows the outer member 528 of the valve assembly 508 of FIG. 6B with the valve seat 514 inserted into the slot 556. The valve seat 514 is shown oriented with its longitudinal axis oriented 90 degrees from the longitudinal axis of the outer member 528 and aligned with the slot 556. In this orientation, the valve seat 514 may be removed from or inserted into the outer member 528. Once fully inserted into the outer member 528, the valve seat 514 may be rotated within the outer member 528 and the surfaces 550, 552 may interlock and the valve seat 514 may be constrained to only rotational movement and may not be removed from the outer member 528 (as shown in FIG. 6E) until the valve seat 514 is returned to an orientation with its longitudinal axis oriented 90 degrees from the longitudinal axis of the outer member 528 and aligned with the slot 556 (as shown in FIG. 6D). In view of this, the end plug 524 (see FIG. 6B) may prevent the separation of the valve seat 514 from the outer member 528 when the valve seat assembly 508 is assembled and installed in the valve housing 510.

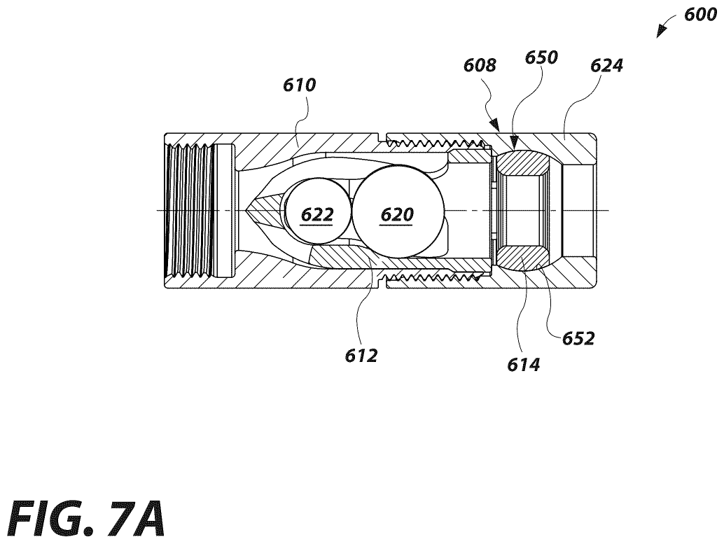

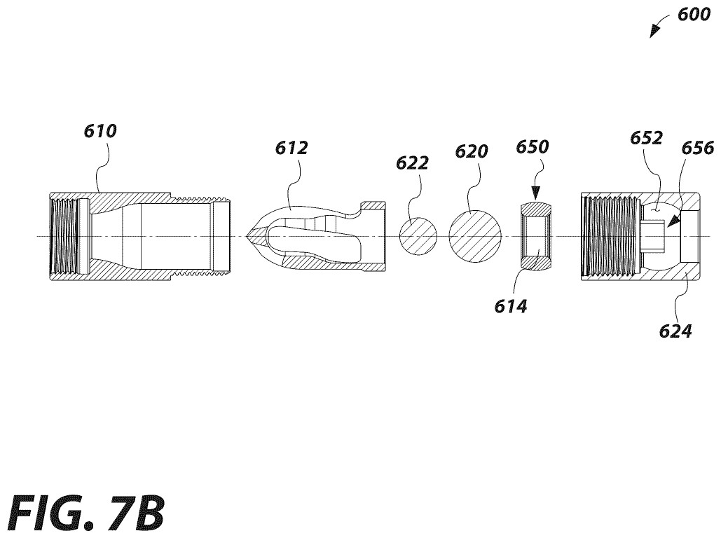

FIG. 7A illustrates a cross-sectional view of a check valve 600 that includes a valve seat assembly 608 having a valve seat 614 configured to tilt relative to a longitudinal axis of the check valve 600, similar to the check valve 500, but utilizing an end plug 624 as an outer member within which the valve seat 614 may tilt, according to an embodiment of the present disclosure.

As noted, the check valve 600 may have similarities to the check valve 500 described with reference to FIGS. 6A-6E. The check valve 600 may have a valve housing 610 that may be substantially the same as the valve housing 510, an insert 612, which may be referred to, alone or in combination with the valve housing 610, as a “cage,” that may be substantially the same as the insert 512, a primary ball 620 that may be substantially the same as the primary ball 520, and a secondary ball 622 that may be substantially the same as the secondary ball 522. Due to the check valve 600 including a valve seat 614 that may tilt, like the check valve 500, the check valve 600 may operate in a non-vertical orientation without the secondary ball 622 in some embodiments, thus the inclusion of the secondary ball 622 is optional.

The valve seat assembly 608 may utilize the end plug 624 attached to the valve housing 610 via a threaded connection as the outer member of the valve seat assembly 608 within which the valve seat 614 may rotate. Accordingly, the end plug 624 may be a single, unitary structure that housing the valve seat 614 without the need for the additional the outer member 528 as shown above.

The valve seat assembly 608 may comprise multiple components including the valve seat 614, the end plug 624, and optionally a seal (not shown—e.g., an O-ring). The valve seat 614 may be positioned within the end plug 624, and the end plug 624 may be secured to the valve housing 610, such as with a threaded connection. An outer surface 650 of the valve seat 614 may be shaped as a portion of a sphere, and a mating inner surface 652 of the end plug 624 may also be shaped as a portion of a sphere, like a ball and socket joint. Accordingly, the valve seat 614 may be rotatable relative to the end plug 624 in every direction and may tilt about a central axis. Optionally, a seal may be positioned within a channel formed in the mating inner surface 652 of the end plug 624 and may inhibit the passage of fluid between the valve seat 614 and the end plug 624. When the valve seat assembly 608, including the end plug 624, are installed in the valve housing 610, the insert 612 may be positioned to allow a limited amount of tilting rotation of the valve seat 614 within the end plug 624, but may provide an obstruction that restricts tilting of the valve seat 614 relative to the end plug 624. For example, the insert 612 may be positioned to restrict tilting rotation of the valve seat 614 within the end plug 624 to a range less than about 90 degrees, to a range less than about 45 degrees, to a range less than about 30 degrees, to a range less than about 20 degrees, to a range less than about 10 degrees, and/or to a range less than about 5 degrees.

FIG. 7B illustrates a cross-sectional view of the check valve 600. Similar to the outer member 528 of the valve seat assembly 508, the end plug 624 may include a slot 656 formed through an end portion and extending in an axial direction to a central portion of the end plug 624, the slot 656 sized and configured to allow the insertion of the valve seat 614 into or out of the end plug 624 when the valve seat 614 is oriented so that the longitudinal axis of the valve seat 614 is perpendicular to a longitudinal axis of the end plug 624.

In this orientation, the valve seat 614 may be removed from or inserted into the end plug 624. Once fully inserted into the end plug 624, the valve seat 614 may be rotated within the end plug 624 and the surfaces 650, 652 may interlock and the valve seat 614 may be constrained to only rotational movement and may not be removed from the end plug 624 until the valve seat 614 is returned to an orientation with its longitudinal axis oriented 90 degrees from the longitudinal axis of the end plug 624 and aligned with the slot 656. In view of this, the insert 612 may prevent the separation of the valve seat 614 from the end plug 624 when the valve seat assembly 608 is assembled and installed in the valve housing 610.

In operation, check valves according to embodiments of the present disclosure, such as the check valves 400, 500, 600, may be utilized to restrict fluid flow with a valve in a single direction, even in applications wherein the longitudinal axis of the check valve is positioned at a non-vertical angle, even a substantially non-vertical angle (e.g., a horizontal position, or near horizontal position). For example, check valves according to embodiments of the present disclosure may operate relatively reliably and relatively quickly in rod lift pumps installed at angles between about vertical to about 65 degrees from vertical, to about 70 degrees from vertical, to about 75 degrees from vertical, to about 80 degrees from vertical, and/or to about 90 degrees from vertical (i.e., horizontal). For example, check valves according to embodiments of the present disclosure may operate relatively reliably and relatively quickly in in rod lift pumps installed at angles between about 2 degrees from vertical to about 80 degrees from vertical. Check valves according to embodiments of the present disclosure may be of particular use at angles above 30 degrees from vertical. For example, check valves according to embodiments of the present disclosure may operate without significant pressure differences between about 30 degrees from vertical to about 75 degrees from vertical.

To restrict fluid flow, the primary ball 420, 520, 620 may be positioned against the valve seat 414, 514, 614. The primary ball 420, 520, 620 may initially apply a force to the valve seat 414, 514, 614 in both a longitudinal direction and a downward direction, due to gravitational forces acting on the primary ball 420, 520, 620. To balance and/or increase the force of the primary ball 420, 520, 620 on the valve seat 414, 514, 614 a force that is non-parallel with a longitudinal axis of the check valve 400, 500, 600 (e.g., a force having an upward component) may be applied with the secondary ball 422, 522, 622.

In some embodiments, such as check valves 500, 600, providing a seal between the primary ball 520, 620 and the valve seat 514, 614 to restrict fluid flow may involve tilting the valve seat 514, 614 relative to the longitudinal axis of the check valve 500, 600 with the primary ball 520, 620.

Check valves according to embodiments of the present disclosure, such as check valves 400, 500, 600, may be utilized in series with other check valves according to embodiments of the present disclosure and/or with conventional check valves, and utilized as traveling valves (e.g., check valves in plunger assemblies) and/or as standing valves (e.g., check valves in barrel assemblies).

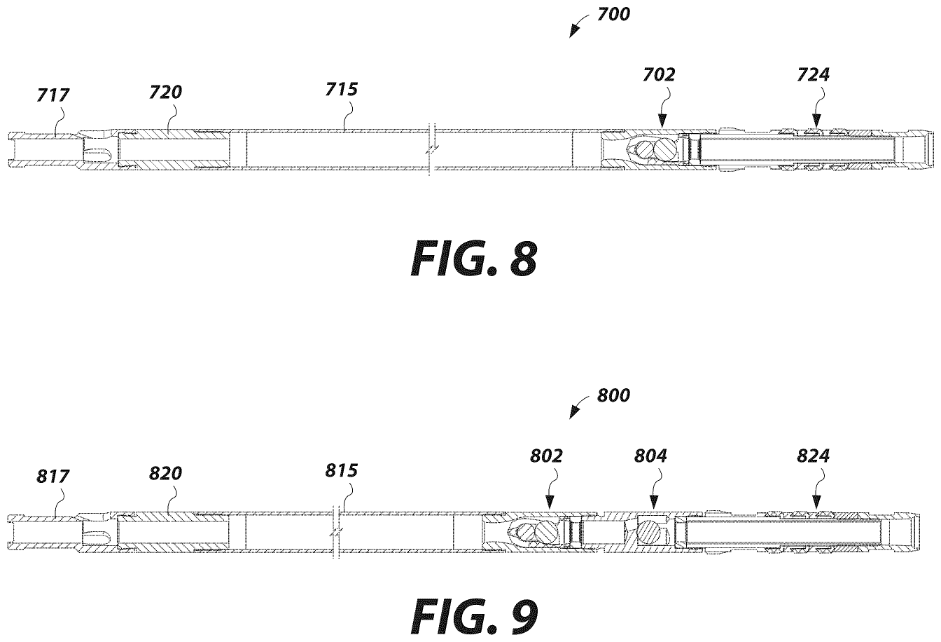

FIG. 8 illustrates a cross-sectional view of a barrel assembly 700 for a sucker-rod pump including a dual-ball check valve 702 utilized as a standing valve, according to an embodiment of the present disclosure. The barrel assembly 700 may additionally include a valve rod guide 717, a connecter 720, a barrel 715, and a hold-down assembly 724. The dual-ball check valve 702 may be located between the barrel 715 and the hold-down assembly 724 and may be substantially the same as one of the check valves 400, 500, 600.

As a plunger assembly travels downward through the barrel 715, a primary ball of the dual-ball check valve 702 may be sealed against a seat and the dual-ball check valve 702 may be closed to inhibit flow through the dual-ball check valve 702, and a secondary ball may press against the primary ball to improve the seal between the primary ball and the seat. When the plunger assembly travels upward through the barrel 715, the primary ball of the dual-ball check valve 702 may be lifted from the seat and the dual-ball check valve 702 may be open to allow flow through the dual-ball check valve 702.

FIG. 9 illustrates a cross-sectional view of a barrel assembly 800 for a sucker-rod pump including a dual-ball check valve 802 and a single-ball check valve 804 in series (e.g., as two standing valves), according to an embodiment of the present disclosure. Like the barrel assembly barrel assembly 700, the barrel assembly 800 may additionally include a valve rod guide 817, a connecter 820, a barrel 815, and a hold-down assembly 824. The dual-ball check valve 802 and the single-ball check valve 804 may be located between the barrel 815 and the hold-down assembly 824, and the dual-ball check valve 802 may be substantially the same as one of the check valves 400, 500, 600. A lower end of the dual-ball check valve 802 may be coupled to an upper end of the single-ball check valve 804.

As a plunger assembly travels downward through the barrel 815, a primary ball of the dual-ball check valve 802 may be sealed against a seat and the dual-ball check valve 802 may be closed to inhibit flow through the dual-ball check valve 802, and a secondary ball may press against the primary ball to improve the seal between the primary ball and the seat. Additionally, as the plunger assembly travels downward through the barrel 815, a ball of the single-ball check valve 804 may be sealed against a seat of the single-ball check valve 804 to further inhibit flow. When the plunger assembly travels upward through the barrel 715, the primary ball of the dual-ball check valve 702 may be lifted from the seat and the dual-ball check valve 702 may be open to allow flow through the dual-ball check valve 702, and the ball of the single-ball check valve 804 may be lifted from the seat of the single-ball check valve 804 to allow flow through the single-ball check valve 804.

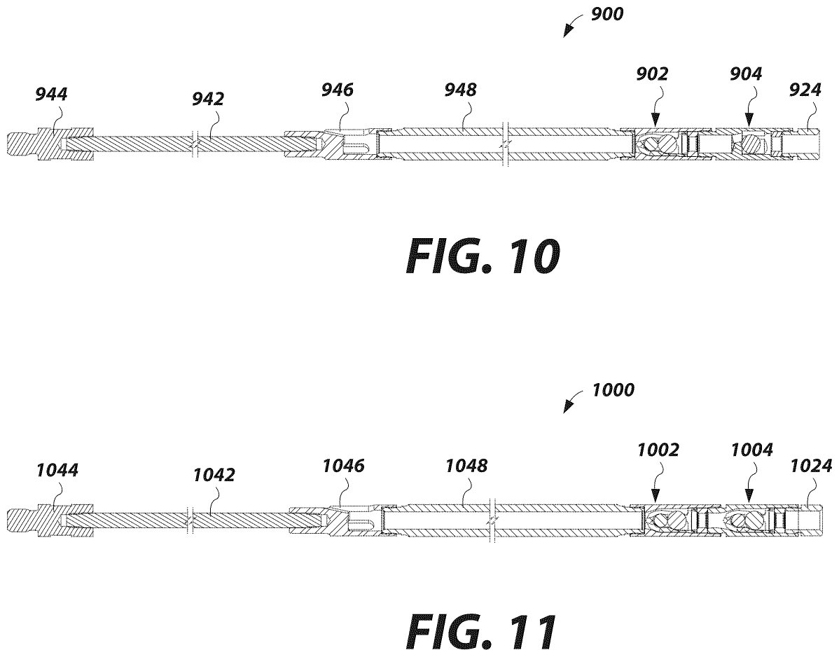

FIG. 10 illustrates a cross-sectional view of a plunger assembly 900 for a sucker-rod pump including a dual-ball check valve 902 and a single-ball check valve 904 (e.g., as two traveling valves) in series, according to an embodiment of the present disclosure. The plunger assembly 900 may additionally include a valve rod bushing 944, a valve rod 942, a plunger coupler 946, a plunger 948, and an end plug 924. The dual-ball check valve 902 and single-ball check valve 904 may be located between the plunger 948 and the end plug 924, and the dual-ball check valve 902 may be substantially the same as one of the check valves 400, 500, 600. A lower end of the dual-ball check valve 902 may be coupled to an upper end of the single-ball check valve 904.

As the plunger assembly 900 travels upward through a barrel, a primary ball of the dual-ball check valve 902 may be sealed against a seat and the dual-ball check valve 902 may be closed to inhibit flow through the dual-ball check valve 902, and a secondary ball may press against the primary ball to improve the seal between the primary ball and the seat. Additionally, as the plunger assembly 900 travels upward through the barrel, a ball of the single-ball check valve 904 may be sealed against a seat of the single-ball check valve 904 to further inhibit flow. When the piston assembly 900 travels downward through the barrel, the primary ball of the dual-ball check valve 902 may be lifted from the seat and the dual-ball check valve 902 may be open to allow flow through the dual-ball check valve 902, and the ball of the single-ball check valve 904 may be lifted from the seat of the single-ball check valve 904 to allow flow through the single-ball check valve 904.

FIG. 11 illustrates a cross-sectional view of a plunger assembly 1000 for a sucker-rod pump including two dual-ball check valves 1002, 1004 in series (e.g., as two traveling valves), according to an embodiment of the present disclosure. The plunger assembly 1000 may additionally include a valve rod bushing 1044, a valve rod 1042, a plunger coupler 1046, a plunger 1048, and an end plug 1024. The dual-ball check valves 1002, 1004 may be located between the plunger 1048 and the end plug 1024, and the dual-ball check valves 1002, 1004 may be substantially the same as one or more of the check valves 400, 500, 600. A lower end of the dual-ball check valve 1002 may be coupled to an upper end of the dual-ball check valve 1004.

As the plunger assembly 1000 travels upward through a barrel, a primary ball of the dual-ball check valve 1002 may be sealed against a seat and the dual-ball check valve 1002 may be closed to inhibit flow through the dual-ball check valve 1002, and a secondary ball of the dual-ball check valve 1002 may press against the primary ball to improve the seal between the primary ball and the seat of the dual-ball check valve 1002. Additionally, as the plunger assembly 1000 travels upward through the barrel, a primary ball of the dual-ball check valve 1004 may be sealed against a seat of the dual-ball check valve 1004 to further inhibit flow, and a secondary ball of the dual-ball check valve 1004 may press against the primary ball to improve the seal between the primary ball and the seat of the dual-ball check valve 1004. When the piston assembly 1000 travels downward through the barrel, the primary ball of the dual-ball check valve 1002 may be lifted from the seat and the dual-ball check valve 1002 may be open to allow flow through the dual-ball check valve 1002, and the primary ball of the dual-ball check valve 1004 may be lifted from the seat of the dual-ball check valve 1004 to allow flow through the dual-ball check valve 1004.

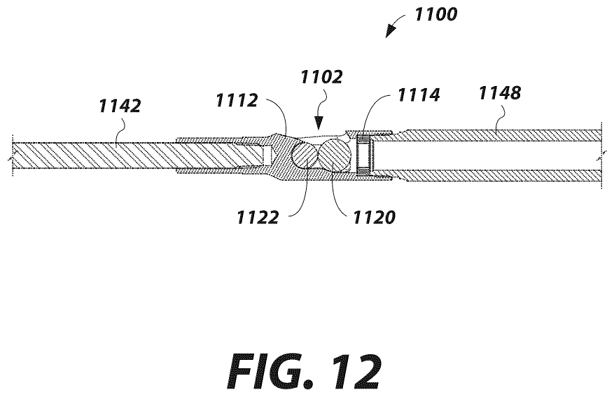

FIG. 12 illustrates a cross-sectional view of a plunger assembly 1100 for a sucker-rod pump including an open-cage dual-ball check valve 1102, according to an embodiment of the present disclosure. In the plunger assembly 1100, a cage 1112 of the open-cage dual-ball check valve 1102 may be utilized as a plunger coupler, coupling a valve rod 1142 to a plunger 1148. Accordingly, the cage 1112 may have an outer diameter that is smaller than or equal to an outer diameter of the plunger 1148 to facilitate the movement of the plunger assembly 1100 through a bore of a barrel.

Additionally, the open-cage dual-ball check valve 1102 may not include a valve housing (as fluids may flow directly out of the plunger 1148 through the cage 1112) and may not include an end plug (as the plunger 1148 may be utilized to maintain a primary ball 1120, a secondary ball 1122, and a valve seat 1114 within the cage 1112). Otherwise, the open-cage dual-ball check valve 1102 may be configured similarly to one of the check valves 400, 500, 600.

In some embodiments, the cage 1112 may be open to enable installation of the balls 1120, 1122 that may be constrained in the case 1112 by the barrel.

In view of the foregoing, check valves and related systems and methods according to embodiments of the present disclosure may provide improved valve operation, especially in substantially deviated and non-vertical wells.

Any equivalents and alternatives along with obvious changes and modifications are intended to be included within the scope of the present disclosure. Accordingly, the foregoing disclosure is intended to be illustrative, but not limiting, of the scope of the disclosure as illustrated by the appended claims.

The title, abstract, background, and headings are provided in compliance with regulations and/or for the convenience of the reader. They include no admissions as to the scope and content of prior art and no limitations applicable to all disclosed embodiments.

While various aspects and embodiments have been disclosed herein, other aspects and embodiments are contemplated. The various aspects and embodiments disclosed herein are for purposes of illustration and are not intended to be limiting. Additionally, the words “including,” “having,” and variants thereof (e.g., “includes” and “has”) as used herein, including the claims, shall have the same meaning as the word “comprising” and variants thereof (e.g., “comprise” and “comprises”). Terms of degree (e.g., “about,” “substantially,” “generally,” etc.) indicate structurally or functionally insignificant variations. In an example, when the term of degree is included with a term indicating quantity, the term of degree is interpreted to mean±10%, ±5%, ±2%, or even ±0% of the term indicating quantity. In an example, when the term of degree is used to modify a shape, the term of degree indicates that the shape being modified by the term of degree has the appearance of the disclosed shape. For instance, the term of degree may be used to indicate that the shape may have rounded corners instead of sharp corners, curved edges instead of straight edges, one or more protrusions extending therefrom, is oblong, is the same as the disclosed shape, etc.

1. A valve, comprising:
a valve seat;
a primary ball sized and positioned to seal against the valve seat when the valve is in a closed state;
a secondary ball sized and positioned to apply a force against the primary ball to facilitate sealing of the primary ball against the valve seat when the valve is in the closed state; and
a cage having the primary ball and the secondary ball located therein, the cage configured to contain the primary ball and the secondary ball within the valve and to allow fluid flow through the valve past the primary ball and the secondary ball when the valve is in an open state.

2. The valve of claim 1, wherein a diameter of the secondary ball is smaller than a diameter of the primary ball.

3. The valve of claim 2, wherein the cage comprises:
a primary ball race having an inner diameter sized to allow longitudinal movement of the primary ball within the primary ball race;
a secondary ball race having an inner diameter smaller than the diameter of the primary ball and larger than the diameter of the secondary ball to allow the longitudinal movement of the secondary ball within the secondary ball race and to prevent the primary ball from entering the secondary ball race; and
a tapered transition region between the primary ball race and the secondary ball race.

4. The valve of claim 3, wherein the cage and the secondary ball are sized and configured so that the secondary ball is located in the tapered transition region when the valve is in the closed state.

5. The valve of claim 1, wherein the cage and the secondary ball are sized and configured so that the secondary ball applies a force to the primary ball in a direction that is non-parallel to a longitudinal axis of the valve when the valve is in the closed state.

6. The valve of claim 1, wherein the cage comprises:
a housing; and
an insert positioned within the housing, the insert comprising ribs extending from a base to an apex, the ribs defining a plurality of flow paths therebetween.

7. The valve of claim 1, further comprising a ball guide positioned proximate the valve seat, the ball guide comprising a tapered opening configured to align the primary ball with the valve seat when the valve is transitioned to the closed state.

8. The valve of claim 1, wherein the valve seat is configured to tilt relative to a longitudinal axis of the valve.

9. The valve of claim 8, wherein the valve seat is positioned in an outer member, the outer member being fixed relative to the cage and the valve seat being rotatable relative to the outer member.

10. The valve of claim 9, further comprises a seal between the outer member and the valve seat.

11. A valve, comprising:
a ball;
a cage having the ball located therein, the cage configured to contain the ball within the valve and to allow fluid flow through the valve past the ball when the valve is in an open state; and
a valve seat sized and configured to receive the ball and provide a seal between the valve seat and the ball when the valve is in a closed state, the valve seat configured to tilt relative to a longitudinal axis of the valve.

12. The valve of claim 11, wherein the valve seat is positioned in an outer member, the outer member being fixed relative to the cage and the valve seat being rotatable relative to the outer member.

13. The valve of claim 12, further comprises a seal between the outer member and the valve seat.

14. The valve of claim 12, wherein an opening of the outer member comprises a surface shaped as a portion of a sphere, and an outer surface of the valve seat comprises a surface shaped as a portion of a sphere.

15. The valve of claim 14, wherein the outer member comprises a slot formed through an end portion and extending in an axial direction to a central portion of the outer member, the slot sized and configured to allow insertion of the valve seat into or out of the outer member when the valve seat is oriented so that the longitudinal axis of the valve seat is perpendicular to a longitudinal axis of the outer member.

16. The valve of claim 15, further comprising an obstruction that restricts tilting of the valve seat relative to the outer member to a range less than 90 degrees.

17. A method of restricting fluid flow with a valve, the method comprising:
positioning a primary ball against a valve seat; and
applying a force to the primary ball in a direction that is non-parallel with a longitudinal axis of the valve with a secondary ball.

18. The method of claim 17, further comprising tilting the valve seat relative to the longitudinal axis of the valve with the primary ball.

19. The method of claim 17, further comprising orienting the longitudinal axis of the valve at a non-vertical angle.

20. The method of claim 17, wherein applying a force to the primary ball in a direction that is non-parallel with a longitudinal axis of the valve with a secondary ball further comprises applying the force in a direction that is non-vertical.
